(19) United States
(12) Patent Application Publication
(10) Pub. No.: US 2015/0032474 A1
(43) Pub. Date: Jan. 29, 2015

(54) SYSTEM AND METHOD FOR GENERATION OF MEDICAL REPORT

(71) Applicant: Agfa HealthCare Inc., Waterloo (CA)

(72) Inventors: George Dobrean, Kitchener (CA); Joost Felix, Arnhem (NL); Wannes Kieckens, Merelbeke (BE); Nadia De Paepe, Nevele (BE)

(73) Assignee: Agfa HealthCare Inc., Waterloo (CA)

(21) Appl. No.: 14/380,092

(22) PCT Filed: Mar. 1, 2013
(86) PCT No.: PCT/CA2013/000188

§ 371 Date: Aug. 21, 2014

Related U.S. Application Data
(60) Provisional application No. 61/605,458, filed on Mar. 1, 2012.

(51) Int. Cl. G06F 19/00

(52) U.S. Cl. CPC G06F 19/322
USPC 705/3

(57) ABSTRACT

A method and system where a user initiates a medical record creation request that is received at a workstation. A results entry structure corresponding to the received medial creation is selected. Result sections entries are received for each of the types of result sections that are required by the record creation request. Result sections entries are stored with the type of result sections within a medical record as stored result sections. The stored result sections are retrievable for generating a medical report from the medical record. A report generation request is received at a workstation and a report structure corresponding to the report generation request is selected. Results sections required by the report generation request are retrieved from medical records and a medical report is generated.

### CROSS-REFERENCE TO RELATED APPLICATIONS

This application is a 371 National Stage Application of PCT/CA2013/000188, filed Mar. 1, 2013. This application claims the benefit of U.S. Provisional Application No. 61/605,458, filed Mar. 1, 2012, which is incorporated by reference herein in its entirety.

### BACKGROUND OF THE INVENTION

1. Field of the Invention

Exemplary embodiments described herein relate to systems and methods in the medical field for creating medical records and generating medical reports.

2. Description of the Related Art

Medical reports, especially radiology reports, are an essential component of a patient's health record. They serve several purposes: medico-legal communication; a standard of comparison with other radiological procedures; a permanent record in the case of lost images; communication with other health professionals; a means of expediting the treatment; and a method to assist in formulating an accurate and precise clinical diagnosis.

The goal of any medical IT system is to improve the quality of care. In this context, report completeness and consistency are generally desired. Medical reporting, especially in the radiology context, is a service used by other clinical specialties including general practice. Therefore medical and radiology reports are used by clinicians and general practitioners. Clinicians and general practitioners are interested in both efficient and effective diagnostic data gathering and diagnostic data analysis and statistics for patient care, research or administration.

### SUMMARY OF THE INVENTION

The embodiments described herein provide in one aspect a method for generating a medical report comprising: receiving at a first workstation a medical record creation request for a medical procedure for a patient; selecting a results entry structure corresponding to the received medical record creation request, the results entry structure indicating one or more section types that are required by the medical record creation request; receiving a result section entry for each of the one or more required section types; and storing within a medical record each of the one or more require section types with the received result section entry as stored result sections, each of the stored result sections being associated with the medical procedure and with the patient, and each of the result sections being retrievable by section type independently of any other stored result sections. In some embodiments, the method comprises receiving a report generation request for generating a report for the medical procedure; selecting a report structure corresponding to the report generation request, the report structure indicating one or more section types required by the report generation request, the required one or more section types being a subset of the section types of the stored result sections; and retrieving from the medical record each of the stored result sections having a section type corresponding to the section types required by the report generation request. Some embodiments of the method may further comprise any of, selecting a report template, generating type-specific medical report; and retrieving report structure or results entry structure from a report structure database.

The embodiments described herein provide in another aspect a system for generating a medical report comprising: a memory for storing a plurality of instructions; a data storage device; and a processor coupled to the memory, the processor configured for:

receiving a medical record creation request for a medical procedure for a patient;

selecting a results entry structure corresponding to the received medical record creation request, the results entry structure indicating one or more section types that are required by the medical record creation request;

receiving a result section entry for each of the one or more required section types; and

storing at the data storage device within a medical record each of the one or more required section types with the received result section entry as stored result sections, each of the stored result sections being associated with the medical procedure and with the patient, and each of the result sections being retrievable by section type independently of any other stored result sections.

In some embodiments, the system may also be configured for: receiving a report generation request for generating a report for the medical procedure; selecting a report structure corresponding to the report generation request, the report structure indicating one or more section types required by the report generation request, the required one or more section types being a subset of the section types of the stored result sections; and retrieving from the medical record each of the stored result sections having a section type corresponding to the section types required by the report generation request. In some embodiments of the system may further be configured for any of, selecting a report template, generating type-specific medical report; and retrieving report structure or results entry structure from a report structure database.

Further aspects and advantages of the embodiments described will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the components of an exemplary embodiment of a medical report generation system.

FIG. 2 is a flowchart illustrating the general operational steps of an exemplary embodiment of the medical report generation system of FIG. 1 for creating a medical report.

FIG. 3 is a schematic diagram illustrating an exemplary embodiment of section reporting format storage of medical records.

FIG. 4 is a schematic diagram illustrating an exemplary embodiment of section groups of a section reporting format storage of a medical record.

FIG. 5 is a flowchart illustrating the general operational steps of an exemplary embodiment of the medical report generation system for generating a medical report.

FIG. 6 is an exemplary medical report generated on a user interface according to one exemplary embodiment of the medical report generation system.

FIG. 7 is an exemplary medical report formatted and generated according to one exemplary embodiment of the medical report generation system.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, tablet, smartphone or cellular telephone. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

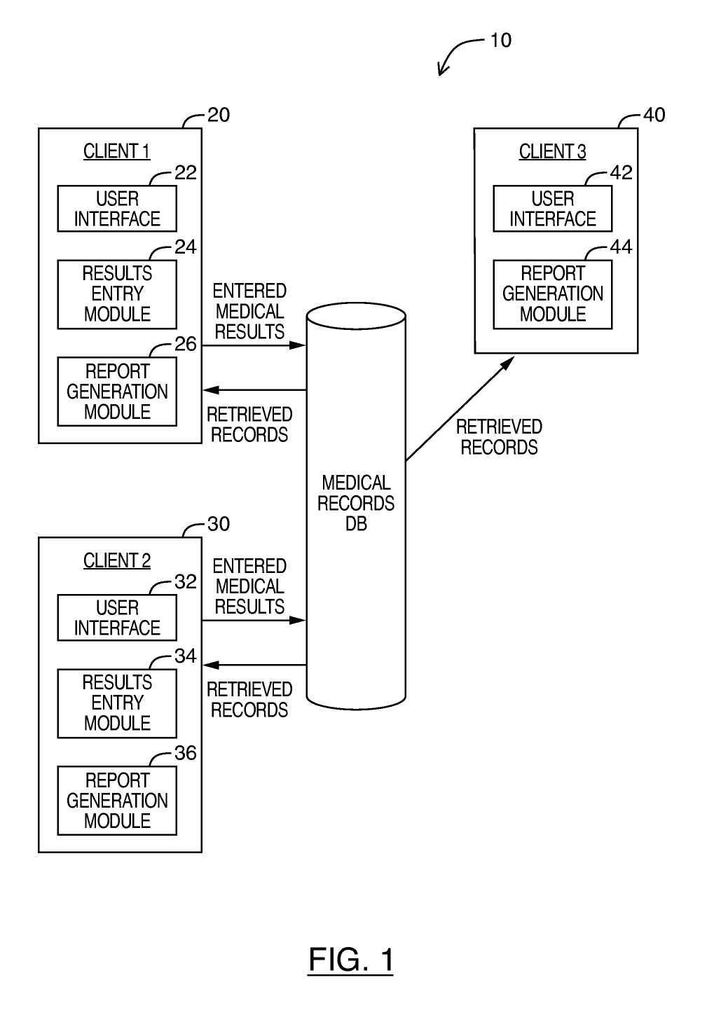

Reference is now made to FIG. 1, which illustrates elements of an exemplary embodiment of a medical report generation system 10. The medical report generation system 10 includes a medical records database 12, and at least a first client workstation 20. The medical report generation system may also include additional workstations such as second client workstation 30, and third client workstation 40. The first client workstation 20 allows users to enter results of a medical procedure in section reporting format into the medical records database 12 and to generate medical reports using the medical records stored in section reporting format in the medical records database 12. Section reporting will be discussed in more detail in the description below. Other client workstations, such as client workstation 30 and client workstation 40, may be configured to perform at least one of the functions of entering results of a medical procedure in section reporting format into the medical records database 12, generating medical reports using the medical reports stored in section reporting format in the medical records database 12 and viewing a generated medical report.

As discussed in more detail elsewhere, it should be understood that the medical report generation system 10 may be implemented in hardware or software or a combination of both. Specifically, the modules of medical report generation system 10 are preferably implemented in computer programs executing on programmable computers, each comprising at least one processor, a data storage system, at least one input device and at least one output device. Without limitation, the programmable computers may be a mainframe computer, server, personal computer, laptop, personal data assistant or cellular telephone. In an exemplary implementation, the medical report generation system 10 is implemented in software and installed on the hard drive of client workstation 20 and on medical records database 12, such that the client workstation 20 interoperates with medical records database 12 in a client-server configuration.

A medical professional who performs a given medical procedure (e.g. a radiology exam) for a given patient, will analyze the output of the medical procedure. For example, the outputs of the medical procedure can be medical images. The medical professional will then record his or her observations of the medical procedure. For example, in the field of radiology, it is typical for the medical professional to analyze medical images of a radiology exam and record her observations of the medical images. The outputs of the medical procedure and the medical professional's observations are recorded within a medical record. A medical report can then be generated from the observations and outputs contained in the medical record. In other cases, the observations and outputs are stored within a medical record, for example in a database. More medical reports can be generated at later time from the stored medical records if desired.

As medical reports for the medical record will later be reviewed by other medical professionals, it is desirable for the medical record to be organized and easy to read. The ease of use of the medical record depends on how the medical professional initially enters observations for the medical procedure performed.

Section reporting is a method of reporting which allows a medical professional to enter observations on the outputs of a medical procedure in an organized manner. The medical professional separately enters observations for various aspects of the medical procedure. For example, in radiology, a radiology procedure will include sections such as radiologist findings, reasons for the procedure, clinical indications, comparison studies, follow-up, image measurements, key images, procedure details, impressions, remarks, conclusions, recommendations and addendum. The separately entered observations are then maintained as result sections, which can then be used to generate a medical report.

Referring back to FIG. 1, the first client workstation 20 comprises a user interface 22, a results entry module 24 and a report generation module 26.

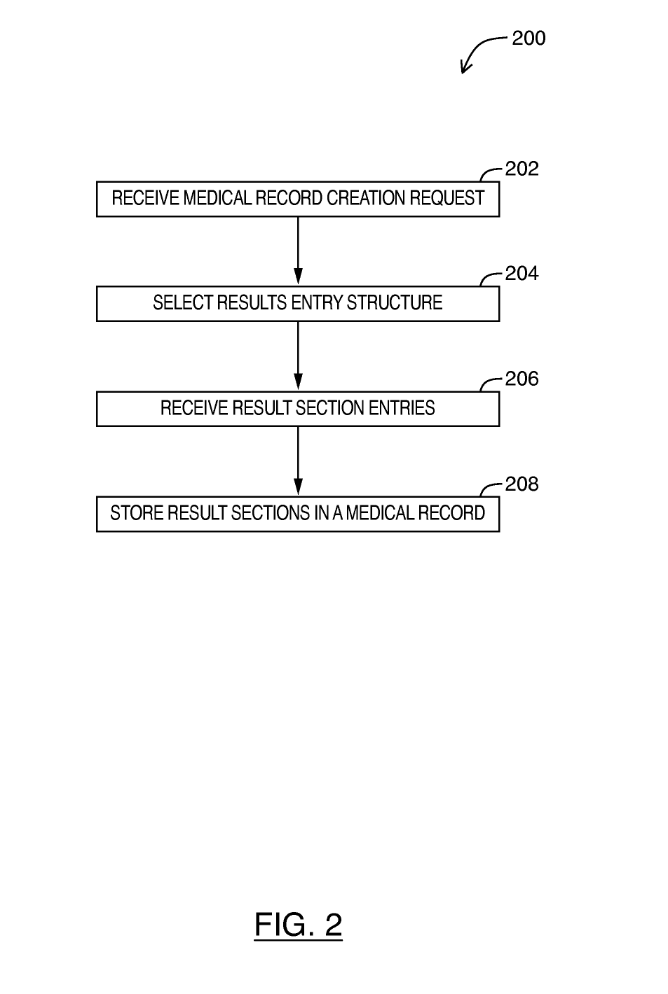

Referring now to FIG. 2, therein illustrated is a schematic diagram of the steps 200 of a method for creating a medical report. The user interface 22 allows a user, such as a medical professional, to interact with the client workstation 20 in order to create a medical record creation request for a given medical procedure for a given patient. For example, the request may be created by selecting an item from a drop down menu, or any other method known in the art. The medical record creation request may also be automatically generated, for example, by the medical equipment that was used by for the medical procedure. The medical record creation request indicates information pertaining to the patient and the medical procedure that is carried out.

At step 202, the results entry module 24 receives the medical record creation request made by the user and initiates a medical record creation session.

At step 204, the results entry module 24 selects a results entry structure that corresponds to the received medical record creation request. The results entry structure indicates one or more section types that need to be entered for the medical record to be created. Each section type refers to a type of observation to be made by the medical professional and to be entered for creating the medical record.

The results entry structure that is selected depends on the medical record to be created. For example, a specific type of medical procedure, such as a mammography, will require specific section types for specific types of observations to be entered. In the case of mammography, these section types may be BI-RADS assessment or BI-RADS score. The results entry structure may also depend on patient information included in medical record creation request. For example, a patient above or below a certain age or being of a specific ethnic background may require specific section types to be entered. For example, in pediatrics, useful sections type may be ones for bone age or development milestones.

In some exemplary embodiments, the results entry module 24 accesses a local database of results entry structures in order to retrieve the results entry structure that corresponds to the medical record to be created.

In other exemplary embodiments, all usable results entry structures may be stored externally, for example on a server, and the results entry module 24 retrieves the corresponding results entry structure from the server. These embodiments may be preferred where many medical professionals are entering medical records from various client workstations. Then, for a same type of medical procedure for a same type of patient carried out in many instances by different medical professionals, the same results entry structure will be retrieved from the server. As a result, medical records created by the different medical professional will all have entered observations for the same set of section types. This ensures uniformity and consistency in the creation of medical reports for a same type of medical procedure.

In some exemplary embodiments, multiple results entry structures may correspond to the medical record creation request. For example, for a medical procedure, it may be possible to create a short form record requiring only a few section types to be complete, or it may be possible to create a long form record for completing a higher number of section types. In these embodiments, the results entry module 24 may present each of the corresponding results entry structures to the user via the user interface 22 to allow the user to select the most appropriate structure.

At step 206, the results entry module 24 presents to the user one or more section queries on the display of the user interface 22. Some of the section queries correspond to section types required by the selected results entry structure for completion by the user. Some of the section queries can correspond to section types for which completion is optional. For example, the section queries may be displayed as empty text boxes which the user can complete via a data entry device such as keyboard, mouse, or dictation device. For a section query, the user enters a result section entry, which is received at the results entry module 24. Result section entries for at least the section types required by the selected results entry structure are received. Each result section entry is associated with a section type.

In some exemplary embodiments, after displaying the sections queries that correspond to the section types required by the results entry structure, the user may further manually modify which section types are required by selectively adding or removing section types to be completed. This allows the user to manually customize the medical record that will be created. For example, this customization can allow a user to add an additional section type that is not part of the selected results entry structure, but which may be important for the given medical procedure or patient.

At step 208, once the result section entries have been received, the results entry module 24 creates a new medical record and stores each result section entry as a stored result section. Each of the stored result sections is identified by its section type and is associated with the medical procedure and the patient. For example, the medical record also stores the patient information and the medical procedure information. For example, each of the result section entries is stored along with the section type for that entry.

Storage may occur locally on the client workstation 20, for example, when a medical report is to be immediately created from the entered opinion and medical procedure results. However, preferably, the entered opinion and medical procedure results are stored as a new medical record in the medical records database 12 in an organized section reporting format to allow easy retrieval of the record for generating medical report at a later time.

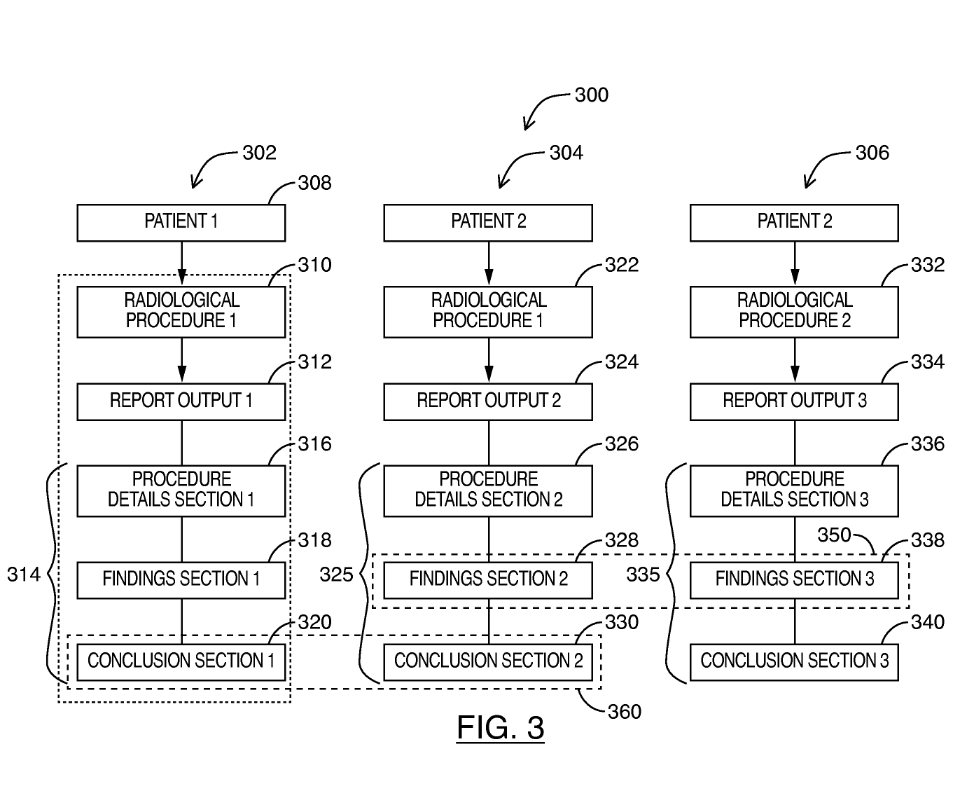

Referring now to FIG. 3, therein illustrated is a schematic diagram of an exemplary embodiment of section reporting format storage 300 of three medical records 302, 304, and 306 after having been created by a results section entry module 24.

First medical record 302 is for a medical procedure for patient 1. Patient data block 308 may indicate patient information, such as name, age and address. Procedure data block 310 may indicate medical procedure information, such as the type of procedure and that date it was carried out. Output data block 312 may comprise the outputs of the medical procedure, such as medical images obtained from the medical procedure. Sections group 314 comprises one or more result sections stored in separate data blocks.

Each of the result sections stored in a separate data block includes the result section entry and the section type completed by the results entry module 24. For example, result section 316 has a section type that is “procedure details” to indicate that the result section pertains to details regarding the medical procedure that was carried out. Result section 318 has a section type that is “findings section” to indicate that the section pertains to the medical professional's findings obtained from the medical procedure. Result section 320 has a section type that is “conclusion section” to indicate that the section pertains to the conclusions that the medical professional has observed from carrying out the medical procedure.

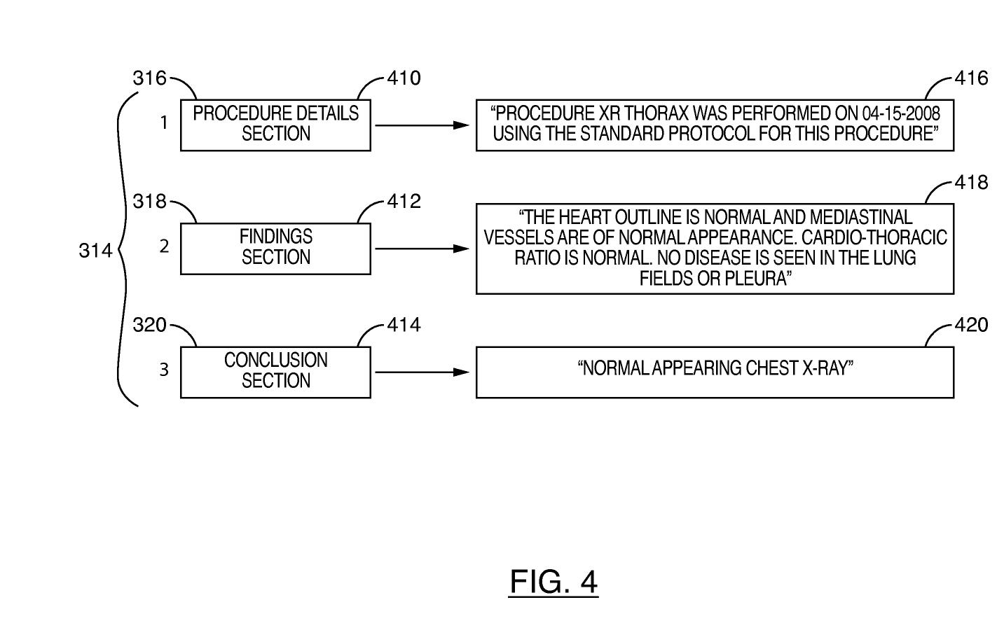

Referring now to FIG. 4, therein illustrated is a schematic diagram of the sections group 314 comprising result sections 316, 318 and 320. Result section 316 has section type 410 indicating “procedure details” and result section entry 416, which includes the entry entered by the professional pertaining to procedure details. Result section 318 has section type 412 indicating “findings section” type and result section entry 418 having the entry from the medical professional. Result section 320 has section type 414, indicating “conclusions section” type and result section entry 420 having the entry from the medical professional of conclusions observed from the medical report.

Referring back to FIG. 3, the exemplary section reporting format storage 300 also includes a second medical record 304 and a third medical record 306. Second medical record 304 also includes a procedure data block 322 and a report data block 324 and a section group 325. Sections group 325 includes result sections 326, 328 and 330. Each of these result sections 326, 328 and 330 also include a section type and a result section entry. Third medical record 306 also includes a procedure data block 332 and report data block 334 and sections group 335. Section group 335 includes result sections 336, 338 and 340. Each of these result sections 336, 338 and 340 also include a section type and a result section entry.

While the sections groups 314, 325 and 335 of the exemplary embodiment each comprise three result sections having the types “procedure details”, “finding section” and “conclusion section”, in other embodiments the section group of a medical record may include at least one result section but can include any number of result sections. Likewise, the types of result sections of a section group of a medical record may vary. This variation depends on the medical procedure that was recorded, which may require a specific number of sections and specific types of sections to be reported for the medical record. The variation can also depend on the results entry structure that was selected for creating the medical record. For example, a long form structure will have more result sections than a short form structure.

Since each result section is separately stored within a separate data block, each result section can be retrieved individually and independently of any other result section stored in another result section data block. For example, it may be possible to retrieve only the “findings section” type result section for procedure 1 of patient 2 stored within result section 328 without having to retrieve the entire medical record. This flexibility allows for more consistent and easier to read medical records when they are presented to a medical professional as a medical report.

Referring back to FIG. 1, the first client workstation 20 also comprises a report generation module 26.

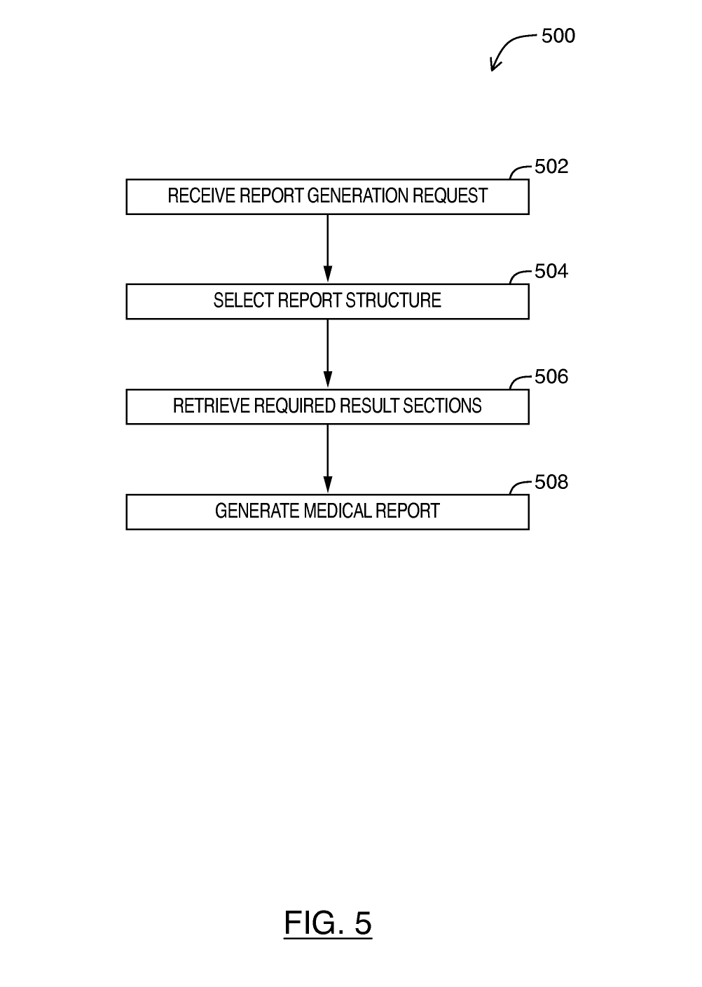

Referring now to FIG. 5, therein illustrated is a schematic diagram of the steps 500 of a method for generating a medical request. The user interface 22 allows a user, such as a medical professional, to interact with client workstation 20 in order to create a report generation request for generating a medical report. In some exemplary embodiments the report generation request is used to generate a medical report for a specific medical procedure carried out for a specific patient. The user creates a report generation request for such a medical report. In some exemplary embodiments a report generation request is automatically created by the results entry module 24 once the storage of the medical record of step 208 is completed.

At step 502, the report generation module 26 of the client workstation 20 receives the report generation request.

At step 504, the report generation module 26 selects a report structure that corresponds to the received report generation request. The report structure includes one or more section types that need to be retrieved in order to generate the medical report.

In some exemplary embodiments, for generation of a medical report, the report structure that is selected will depend on the medical procedure for which the medical report is to be generated as discussed above. For example, a specific type of medical procedure, such as mammography, will require specific section types to be retrieved and reported in the medical report. These sections may be BI-RADS assessment or BI-RADS score. The report structure may also depend on the patient for which the medical report is to be generated. For example, a patient above or below a certain age or being of a specific ethnic background may require specific types of reporting sections to be completed. For example, in pediatrics, useful sections type may be ones for bone age or development milestones.

In some exemplary embodiments, the section types that are required by the selected report structure are a subset of the section types that are stored as result sections within a medical record. For example, a medical record created according to a long form results entry structure will have many stored result sections having many section types. A short form report structure corresponding to a report generation request will only require a subset of the stored result sections. It will be understood that subset herein refers to all of the sections types of a stored result section, or less than all of the section types of the stored result section.

In some exemplary embodiments, the report structure may be the same as the results entry structure for creation of a medical record, as both structures indicate a number of section types that are required. For example, for a mammography, the results entry structure will indicate the “procedure details”, “findings section” and “conclusion section” types are required in order to achieve a complete medical record for the mammography. When generating a report for the mammography, the report structure for this medical procedure will also indicate that the “procedure details”, “findings section” and “conclusion section” types are required. In these embodiments, it is possible for corresponding results entry structures and report structures to be stored as one structure to be both retrievable by the results entry module 24 during medical record creating phase, and by the report generation module 26 during medical report generation phase.

In some exemplary embodiments, all usable results entry structures and report structures may be stored externally, for example on a server, and the report generation module 26 retrieves the corresponding report structure from the server. These embodiments may be preferred where many medical professionals are retrieving medical records from various client workstations. Then, for a same type of medical procedure for a same type of patient carried out at many instances by different medical professionals, the same report structure requiring the same set of reporting section types will be retrieved from the server. As a result, medical records created by the different medical professionals will all have the same set of types of completed reporting sections. This ensures uniformity and consistency in the creation of medical reports for a same type of medical procedure.

In some exemplary embodiments, more than one report structure may correspond to the report generation request. For example, for a medical procedure, it may be possible to create a short form report requiring only a few section types to be completed, or it may be possible to create a long form report requiring a higher number of section types. In these embodiments, the report generation module 26 may present each of the corresponding report structures to the user via the user interface 22 to allow the user to select the most appropriate structure.

In some exemplary embodiments, the report generation request received by the report generation module 26 may be used to generate a medical report for a specific medical procedure undergone by a specific patient. In such embodiments, the report generation module 26 retrieves the information stored in association with that medical procedure in the data blocks from the medical records database 12, which will include at least some of the information stored in the stored result sections of that medical record.

Referring back to FIG. 3, it will be appreciated that when a medical report is to be created for a specific medical procedure, retrieval of information from the stored medical records is undertaken “vertically”. That is, data blocks associated with one specific patient and one medical procedure are retrieved. For example, medical record 302 is for patient 1, as indicated by data block 308, and for medical procedure 1, as indicated by data block 310. To create a medical report for this procedure, retrieval is performed “vertically” to retrieve each of the data blocks contained within box 350 denoted by the dotted lines. In this example, the medical procedure data block 310, report output data block 312, procedure details section 316, findings section 318, and conclusion section 320 are retrieved in order to generate the report. However, it will be understood that each of the results sections stored within the result sections group 314 do not need to be retrieved, and in some cases only some of the results sections stored therein will be required for generating a medical report.

At step 506, the report generation module 26 retrieves each of required data blocks and each of the stored results sections having a type corresponding to the section types required by the selected report structure.

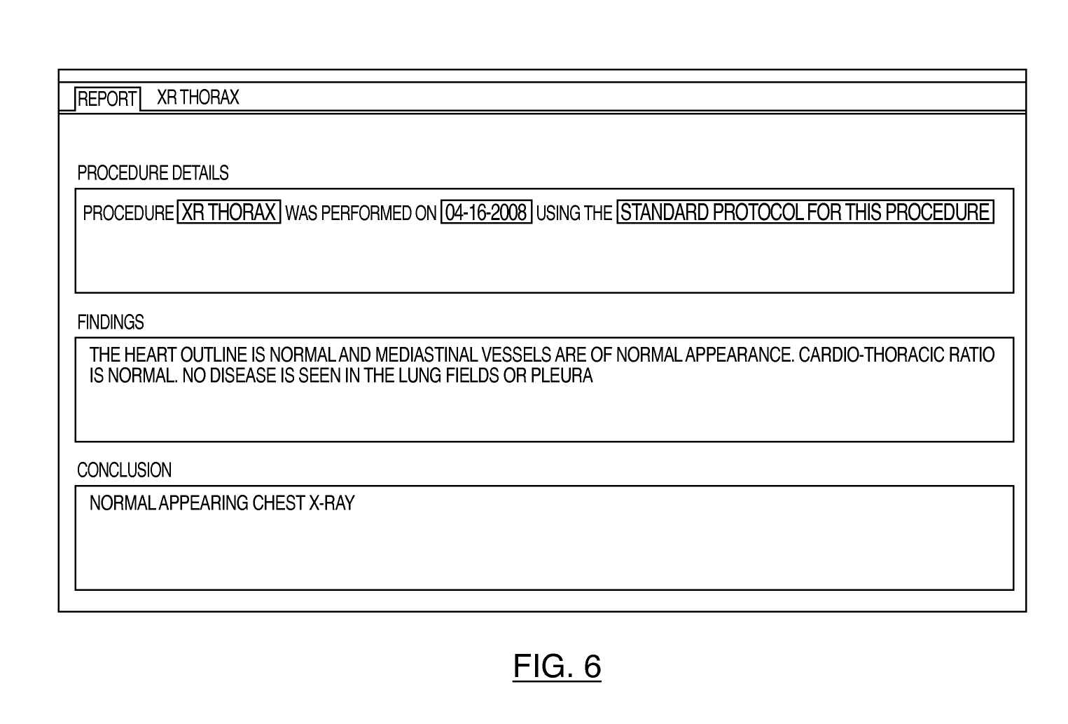

At step 508, in some exemplary embodiments, a medical report is generated by displaying the retrieved result sections by showing for each retrieved section the section type and the result section entry. For example FIG. 6 shows an exemplary medical report 600 that may be displayed on the user interface 22. Each of the section types “procedure details”, “findings” and “conclusion” are displayed as headings. Beneath each heading, the corresponding results section entry is displayed.

In some exemplary embodiments, the medical report may be generated at step 508 from a report template. In these embodiments, when the report generation module 26 receives a report generation request, it selects a report template corresponding to the report generation request. The selected report template includes one or more areas to be populated. Each area to be populated corresponds to the one or more result section entries for the section type required by the report generation request and indicated by the selected report structure. In addition, the template will include one or more areas to be populated by presentation features. These features, such as report header and reporting medical professional signature, are selected depending on who is generating the medical report or who originally created the medical record. In addition, the report template may indicate a layout, such as color, font, and size, of the medical report.

The report generation module 26 completes the medical report by populating each of the result section areas of the template with the result section entry corresponding to the section type for that area. The report generation module 26 also populates each of the presentation areas of the template with the presentation feature corresponding to the presentation area.

Generation of a medical report from a report template ensures ease of use and consistency for a medical professional who will examine the report. For example, despite medical records having been created by many different medical professionals at various sites, such as departments, hospitals or clinics, the generated medical report will always have a consistent and layout and feel according to the report template. A medical professional who is accustomed to this layout and feel will find the report easy to read and disseminate.

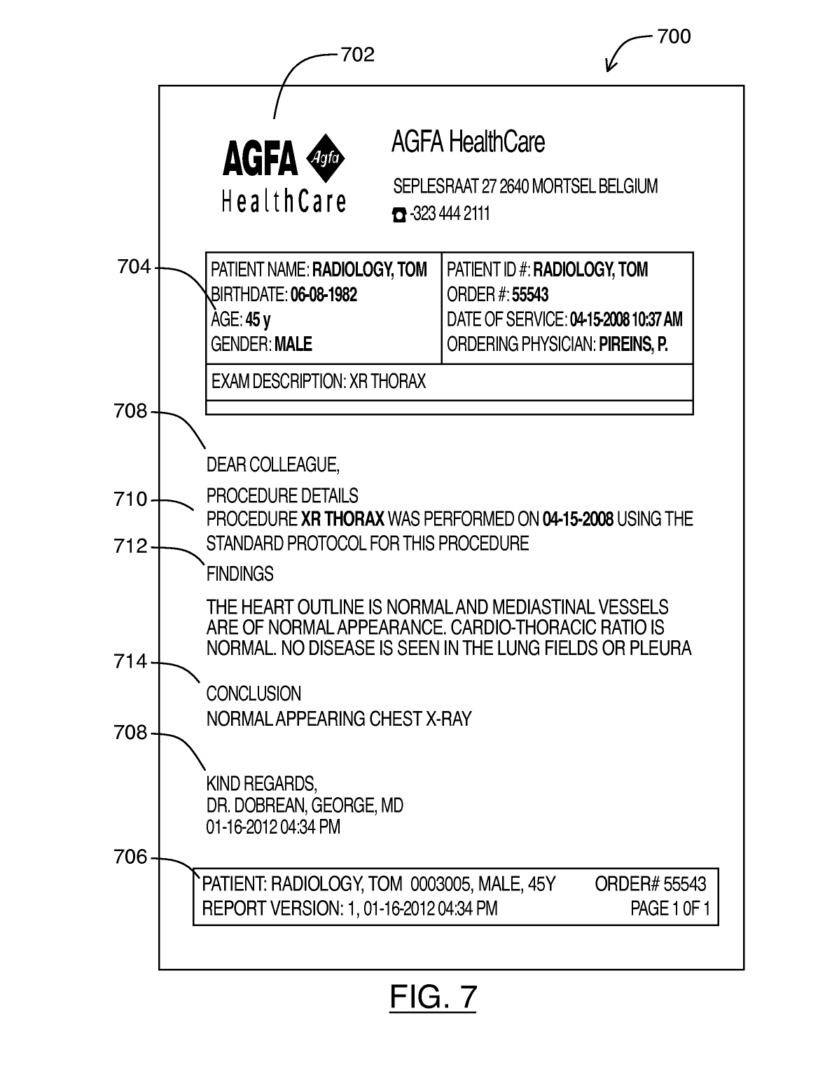

FIG. 7 shows a medical report 700 generated from a report template that includes the same results section types and results section entries as the medical report shown in FIG. 6. Medical report 700 comprises presentation features such as report header 702, patient information 704, reporter signature 706, and salutation 708. Medical report 700 also includes result section areas 710, 712, and 714, which have been populated by the result section entries of section types “procedure details”, “section findings” and “conclusion”.

It will be appreciated, that in exemplary embodiments where a medical record is stored at the medical records database 12, once the medical records entry process is completed, the medical record stored at the medical records database 12 can be accessed by other client workstations. For example, a second workstation 30 that also includes a user interface 32, a results entry module 34 and a report generation module 36 may be in communication with the medical records database 12 to retrieve medical records stored thereon.

In this case, after a first medical professional has used client workstation 20 to create a medical record for one medical procedure for a patient and has stored that medical record in the medical records database 12, a second user may access the medical records database 12 using the second client workstation 30 to generate a report for the medical procedure for that patient. The second user interacts with the user interface 32 of the second client workstation 30 to send a report generation request to report generation module 36. The report generation module 36 then selects a corresponding report structure and retrieves the required result sections for the medical report generation request from the medical records database 12.

Since the medical record created by the first client workstation 20 includes one or more result sections that are separately stored in section data blocks, the entries for each result section can be separately retrieved according to the type of the section independently of any other stored result sections. This allows the second user to customize the content of the medical report to be generated using the second client workstation 30. Therefore, in generating the medical report, the second user is not limited by how the first user created the medical record at the first client workstation 20. For example, the second user may want to have a short form medical report that only contains the most relevant result sections. Referring back to FIG. 3, the second user may wish to create a report that contains only the patient information, procedure information, findings section and conclusion section but is not concerned with the information contained in the procedure details section.

In some exemplary embodiments, the report generation module 36 of the second client workstation 30 may generate the medical report from a report template. The report template may be customized for users of the second client workstation, for example if the second client workstation 30 is used at a research department, hospital or clinic that is different from that of the first client workstation 20. Alternatively, report templates may be retrieved from a report templates database that stores report templates for many different medical institutions. In this way, a medical report may be generated to have the layout and feel according to the medical institution that performed the medical procedure and created the medical record.

In some exemplary embodiments, a client workstation that is in communication with the medical records database 12 is configured to only generate medical reports and is not configured for creation of medical records. This may be the case for clinicians who often need to access medical records of a patient, for example to examine a prior radiology exam, but do not need carry out medical procedures that require the creation of a medical record. For example, third client workstation 40 has a user interface 42 and report generation module 44 but does not have a results entry module. The client workstation 40 is further in communication with medical records database 12 to retrieve medical records and the medical report generation module 44 can create medical reports corresponding to medical generation requests made by a user through user interface 42 of client workstation 40.

In a typical instance, a medical report will be generated for a specific medical procedure for a specific patient. As described above with reference to FIG. 3, generation of such a medical report includes “vertical” retrieval of information through one medical record for one medical procedure for one patient of the stored medical records. However, the storing of result sections in separate data blocks such that each is independently retrievable achieves greater flexibility in the generation of medical reports.

Referring back to FIG. 3, it will be appreciated that the medical records 302, 304, and 306 are already stored in the database. It will be further appreciated that since each result section is identifiable by section type, it is possible to selectively retrieve result section entries of individual stored result sections. Importantly, it is possible to retrieve the result section based on the section type independently of the medical procedure and patient to which the result section is associated to within the medical record.

For example, in some exemplary embodiments, it is possible to generate a patient-specific medical report that is not limited to a single medical procedure or a single type of medical procedure. That is, a plurality of result sections having the same section type and being associated with the same patient can be retrieved independently of the medical procedure or type of medical procedure to which each of the result sections are associated. For example, box 350 of FIG. 3 encompasses the “findings section” for two different medical procedures for the same patient stored in medical records 304 and 306. By retrieving, at step 506, the two result sections of “findings section” type, it is possible to create a medical report that includes both result section entries for the two results sections. Such a medical report would allow a medical professional examining the medical report to quickly compare the result section entries in the “findings section” for multiple medical procedures without having to read through multiple complete medical reports. For example, this type of report would allow a medical professional to quickly track the progress for that patient over a plurality of medical procedures.

In some exemplary embodiments, it may be possible to generate a procedure-specific medical report that is not limited to a single patient or type of patient. That is, a plurality of result section having the same section type and being associated with the same type of medical procedure can be retrieved independently of the medical procedure or type of medical procedure to which each of the result sections are associated. For example, box 360 of FIG. 3 encompasses the “conclusions section” for two different patients, but for the same type of medical procedure. By retrieving, at step 506, the two results of “conclusion section” type, it is possible to create a medical report that includes both result section entries for the two result sections. Such a medical report would allow a user to compare the conclusions drawn for a same type of medical procedure for various patients. This type of report would be particularly useful, for example, for research purposes.

It will be appreciated that the reporting section format storage wherein each stored result section of medical records can be retrieved independently of any other stored result section within the same medical record and further that can be retrieved independently of the medical procedure and patient to which it is associated within the same medical record, allows for greater flexibility and consistency in the retrieval of information contained in stored medical records. It will be further appreciated that any combination of section types for different types of medical procedure and patient can be retrieved for the creation of medical record, and types of medical reports that can be generated according to the method and system described herein are not limited to the embodiments described.

While the various exemplary embodiments of the medical report generation system 10 have been described in the context of medical image management in order to provide an application-specific illustration, it should be understood that the medical report generation system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1-15. (canceled)

16. A method for generating a medical report, the method comprising:
receiving a medical record creation request for a medical procedure for a patient;
selecting a results entry structure corresponding to the medical record creation request, the results entry structure indicating one or more section types that are required by the medical record creation request;
receiving a result section entry for each of the one or more section types; and
storing within a medical record each of the one or more section types with the result section entry as stored result sections, each of the stored result sections being associated with the medical procedure and with the patient, and each of the stored result sections being retrievable by section type independently of any other of the stored result sections.

17. The method of claim 16, further comprising the steps of:
receiving a report generation request to generate a report for the medical procedure for the patient;
selecting a report structure corresponding to the report generation request, the report structure indicating one or more section types required by the report generation request, the one or more section types being a subset of the section types of the stored result sections; and
retrieving from the medical record each of the stored result sections having a section type corresponding to the section types required by the report generation request.

18. The method of claim 17, further comprising the steps of:
selecting a report template for the report generation request, the report template including one or more areas, each of the one or more areas to be populated with a section type required by the report generation request; and
populating each of the one or more areas of the template with the result section entry of a retrieved stored results section having the type corresponding to the section type for that area.

19. The method of claim 16, wherein the medical record is stored in a database including a plurality of already stored medical records, each of the plurality of already stored medical records including medical procedure information and patient information and one or more result sections associated with the medical procedure and the patient, each of the one or more result sections including a result section entry and a section type, each of the one or more result sections of the plurality of already stored records and the result sections of the medical record being selectively retrievable based on section type independently of the medical procedure and the patient to which each of the result sections are associated.

20. The method of claim 19, further comprising the steps of:
receiving a report generation request to generate a procedure-specific medical report;
retrieving a plurality of result sections having the same section type and being associated with the same type of medical procedure independently of the patient to which each of the result sections are associated; and
generating a medical report from the retrieved plurality of result sections.

21. The method of claim 19, further comprising the steps of:
receiving a report generation request to generate a patient-specific medical report;
retrieving a plurality of result sections having the same type and being associated with the same patient independently of the medical procedure to which each of the result sections are associated; and
generating a medical report from the plurality of result sections.

22. The method of claim 17, wherein the medical record creation request is received at a first workstation, the report generation request is received at a second workstation, and the stored result sections are retrieved by the second workstation.

23. A system for generating a medical report, the system comprising:
a memory configured to store a plurality of instructions;
a data storage device; and
a processor coupled to the memory, the processor configured and programmed to receive a medical record creation request for a medical procedure for a patient; to select a results entry structure corresponding to the medical record creation request, the results entry structure indicating one or more section types that are required by the medical record creation request; to receive a result section entry for each of the one or more section types; and to store in the data storage device within a medical record each of the one or more section types with the result section entry as stored result sections, each of the stored result sections being associated with the medical procedure and with the patient, and each of the stored result sections being retrievable by section type independently of any other stored result sections.

24. The system of claim 23, wherein the processor is configured and programmed to receive a report generation request to generate a report for the medical procedure for the patient; to select a report structure corresponding to the report generation request, the report structure indicating one or more section types required by the report generation request, the one or more section types being a subset of the section types of the stored result sections; and to retrieve from the medical record each of the stored result sections having a section type corresponding to the section types required by the report generation request.

25. The system of claim 24, wherein the processor is configured and programmed to select a report template for the report generation request, the report template including one or more areas, each of the one or more areas to be populated with a section type required by the report generation request; and to populate each of the one or more areas of the template with the result section entry of a retrieved stored results section having the type corresponding to the section type for that area.

26. The system of claim 23, wherein the data storage includes a plurality of already stored medical records, each of the plurality of already stored medical records including medical procedure information and patient information and one or more result sections associated with the medical procedure and the patient, each of the one or more result sections including a result section entry and a section type, each of the one or more result sections of the plurality of already stored records and the result sections of the medical record being selectively retrievable based on section type independently of the medical procedure and the patient to which each of the result sections are associated.

27. The system of claim 26, wherein the processor is configured and programmed to receive a report generation request to generate a procedure-specific medical report; to retrieve a plurality of result sections having the same section type and being associated with the same type of medical procedure independently of the patient to which each of the result sections are associated; and to generate a medical report from the plurality of result sections.

28. The system of claim 26, wherein the processor is configured and programmed to receive a report generation request to generate a patient-specific medical report; to retrieve a plurality result sections having the same type and being associated with the same patient independently of the medical procedure to which each of the result sections are associated; and to generate a medical report from the plurality of result sections.

29. The system of claim 24, wherein the medical record creation request is received at a first workstation, the report generating request is received at a second workstation, and the stored result sections are retrieved by the second workstation.

30. A non-transitory computer-readable medium including instructions for performing, when the instructions are executed by a processor, the steps of the method as claimed in claim 16.
